(19) United States
(12) Patent Application Publication
(10) Pub. No.: US 2014/0244020 A1
(43) Pub. Date: Aug. 28, 2014

(54) ANOMALY DETECTION METHOD, COMPUTER-READABLE NON-TRANSITORY STORAGE MEDIUM, AND ANOMALY DETECTION APPARATUS

(71) Applicant: Kabushiki Kaisha Toshiba, Tokyo (JP)

(72) Inventor: Takahiro IKEDA, Yokohama-Shi (JP)

(73) Assignee: Kabushiki Kaisha Toshiba, Tokyo (JP)

(21) Appl. No.: 14/010,222

(22) Filed: Aug. 26, 2013

(30) Foreign Application Priority Data
Feb. 28, 2013 (JP) 2013-038994

(51) Int. Cl. G05B 19/418

(52) U.S. Cl. CPC G05B 19/41875
USPC 700/110

(57) ABSTRACT

In accordance with an embodiment, an anomaly detection method includes acquiring coordinate data of defects or particles generated on a wafer during a semiconductor manufacturing process, calculating an Eberhardt's index from the acquired data, calculating a first probability point, comparing the calculated Eberhardt's index with the first probability point, and judging presence/absence in state of a spatial point distribution relative to the defects or the particles. The first probability point is calculated based on a sample distribution of the Eberhardt's index.

### CROSS REFERENCE TO RELATED APPLICATIONS

This application is based upon and claims the benefit of priority from the prior Japanese Patent Application No. 2013-038994, filed on Feb. 28, 2013, the entire contents of which are incorporated herein by reference.

### FIELD

Embodiments described herein relate generally to an anomaly detection method, a computer-readable non-transitory storage medium, and an anomaly detection apparatus.

### BACKGROUND

A yield rate of a semiconductor device such as a semiconductor integrated circuit is greatly affected by particles or defects generated on a wafer at each step in a manufacturing process, and the yield rate usually lowers when the number of particles or defects increases. Therefore, an increase or a decrease in number of particles or defects or generation conformations is steadily monitored by conducting a particle check or a defect examination in various processes.

However, when an increase or a decrease in number of the particles the defects is monitored alone, it is very difficult to identify a cause that increases or decreases them.

### BRIEF DESCRIPTION OF THE DRAWINGS

FIG. 1 is a flowchart showing an outline procedure of an anomaly detection method according to Embodiment 1;

FIG. 2 is a view showing an example of an Eberhardt's index control chart created by the procedure depicted in FIG. 1;

FIG. 3A is a view showing an example of a wafer map of defects corresponding to the range considered to be random in the control chart depicted in FIG. 2;

FIG. 3B is a view showing an example of a wafer map of defects corresponding to the range considered to have a cluster in the control chart in FIG. 2;

FIG. 4 is an explanatory view of an example of a wafer map obtained by an anomaly detection method according to Embodiment 2;

FIG. 5 is an explanatory view showing another example of the wafer map obtained by the anomaly detection method according to Embodiment 2; and

FIG. 6 is a block diagram showing an outline configuration of an anomaly detection apparatus according to Embodiment 1.

### DETAILED DESCRIPTION

In accordance with an embodiment, an anomaly detection method includes acquiring coordinate data of defects or particles generated on a wafer during a semiconductor manufacturing process, calculating an Eberhardt's index from the acquired data, calculating a first probability point, comparing the calculated Eberhardt's index with the first probability point, and judging presence/absence in state of a spatial point distribution relative to the defects or the particles. The first probability point is calculated based on a sample distribution of the Eberhardt's index.

Embodiments will now be explained with reference to the accompanying drawings. Like components are provided with like reference signs throughout the drawings and repeated descriptions thereof are appropriately omitted.

(A) Anomaly Detection Method

(1) Embodiment 1

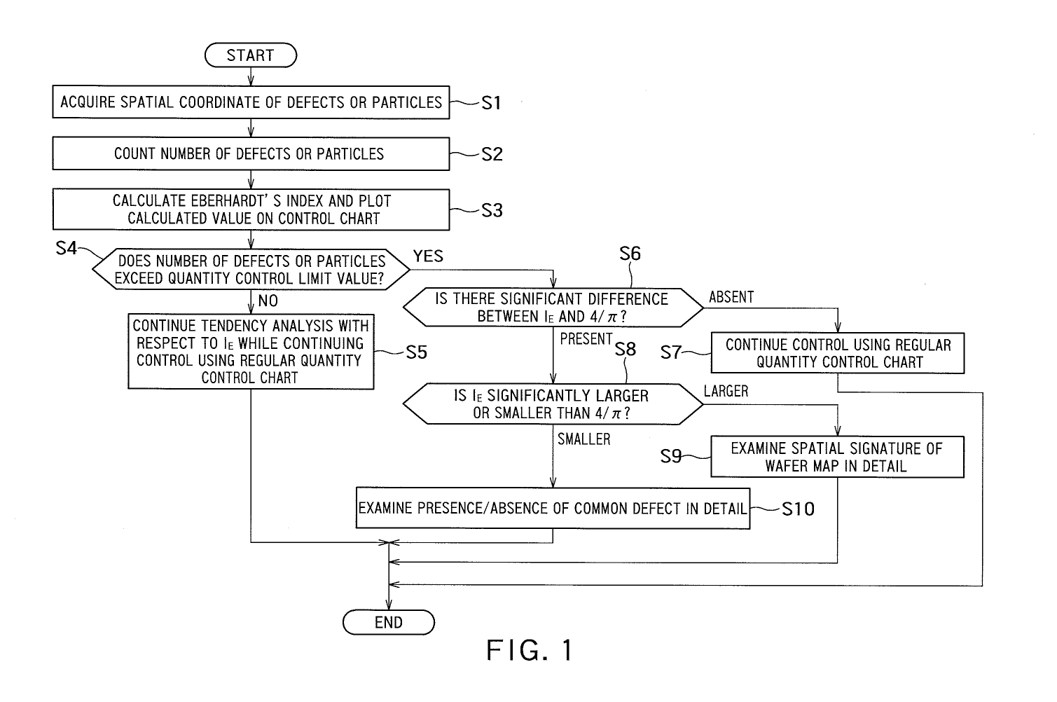

FIG. 1 is a flowchart showing an outline procedure of an anomaly detection method according to Embodiment 1.

First, one wafer as an anomaly detection target that is being processed in a semiconductor manufacturing process is sampled and subjected to defect or particle examination by a non-illustrated examination apparatus, whereby a spatial coordinate of detected defects or particles is obtained (a step S1).

Then, the number of detected defects or particles is counted (a step S2), and this value is plotted on a quantity control chart (not shown).

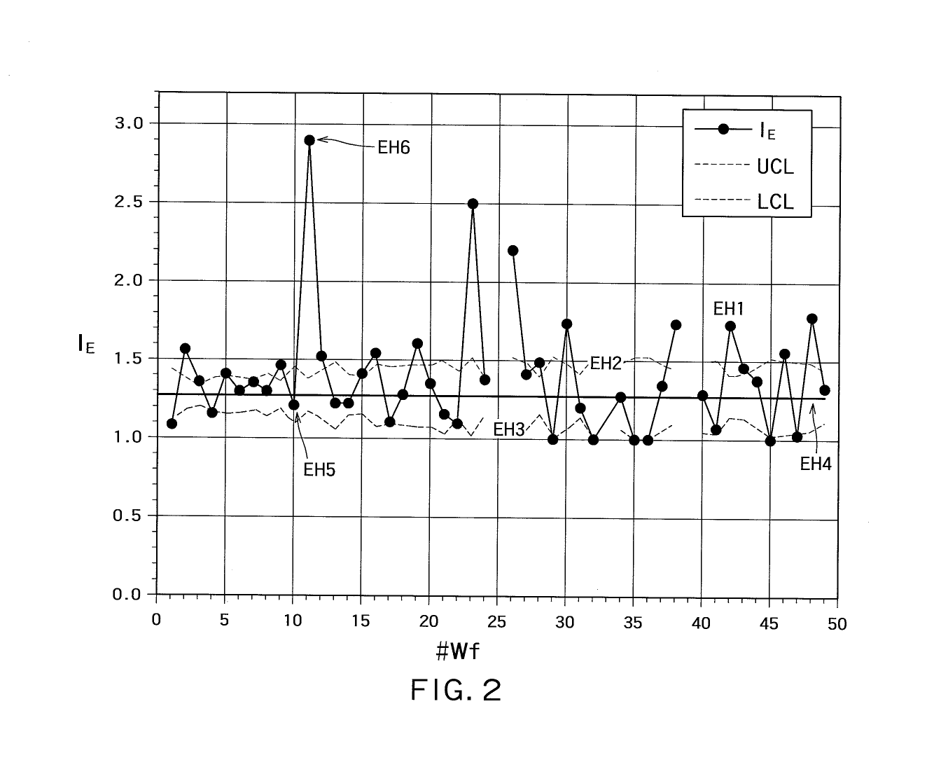

Subsequently, coordinate data of the detected defects or particles is acquired, and an Eberhardt's index I_{E} represented by the following Expression (1) is calculated, and an obtained value is plotted on an Eberhardt's index control chart (see FIG. 2) (a step S3)

$${I}_{E} = \frac{N {\sum }_{i = 1}^{N} {d}_{i}^{2}}{{( {\sum }_{i = 1}^{N} {d}_{i} )}^{2}} . \qquad ( 1 )$$

In Expression (1), di is a distance to the nearest neighbor relative to an ith point.

Here, it is known that a value of the Eberhardt's index I_{E} substantially coincides with 4/π when the spatial point distribution of particles is a Poisson type, i.e., a random spatial distribution, it is a value larger than 4/π when this distribution is of an aggregative type, i.e., a cluster is present, or it is a value smaller than 4/π when each interval between points is close to an equal interval.

Then, a judgment is made upon whether the counted number of the defects or the particles exceeds a quantity control limit value (a step S4). As a result of the judgment, when the number of the defects or the particles exceeds a predetermined quantity control value, an Eberhardt's index is calculated, the obtained Eberhardt's index and its reliability limit value are compared with each other, and whether there is a significant difference is present is checked (a step S6).

Specifically, the Eberhardt's index I_{E} is calculated by using Expression (1), and the obtained Eberhardt's index I_{E} is compared with an expectation value of I_{E} in the case of the Poisson distribution (which will be referred to as an “Eberhardt's index control reference value” hereinafter) 4/π to determine which one is larger or smaller. When the calculated Eberhardt's index I_{E} is significantly larger than the Eberhardt's index control reference value 4/π, its spatial point distribution is considered to be aggregative. When the calculated Eberhardt's index I_{E} is significantly smaller than the Eberhardt's index control reference value 4/π, its spatial point distribution is considered to be regular. A value that functions as a border between these values is given by an upper probability point and a lower probability point of Eberhardt's index sample analysis. Although the lower probability point of 5% and the upper probability point of 95% are often used, convenient probability points can be appropriately used in accordance with an anomaly occurrence frequency or an allowed examination cost in this embodiment. For example, when the upper probability is reduced or the lower probability is increased, it is often the case that a significant difference from the Eberhardt's index reference value is determined to be present, and hence more wafer maps are eventually observed in detail. In this embodiment, values shown in W. G. S. HINES and R. J. O′HARA HINES: “The Eberhardt statistics and the detection of non-randomness of spatial point distributions, Biometrika (1979), 66,1,pp. 73-74 are used, and each of these values corresponding to the number of defects is used as, e.g., a first probability point.

When the number of defects or particles exceeds a predetermined quantity control value as a result of a judgment (a step S4, Yes) but there is no significant difference between the calculated Eberhardt's index I_{E} and the Eberhardt's index control reference value 4/π (a step S6, absent), control using the usual quantity control chart is continued (a step S7).

When the number of defects or particles exceeds the predetermined quantity control value as a result of the judgment (the step S4, Yes) and there is a significant difference between the calculated Eberhardt's index I_{E} and the Eberhardt's index control reference value 4/π (a step S6, present), a wafer map of this wafer is examined in detail.

Specifically, when the calculated Eberhardt's index I_{E} is significantly larger than the Eberhardt's index control reference value 4/π (a step S8, larger), attention is paid to presence of a cluster, and characteristics of a spatial point distribution (spatial signature) of the wafer map are examined in detailed (a step S9).

On the other hand, when the calculated Eberhardt's index I_{E} is significantly smaller than the Eberhardt's index control reference value 4/π (the step S8, smaller), the attention is paid to presence of a common defect, and the spatial point distribution of the defects or the particles on the wafer is examined in detail (a step S10).

Further, as a result of the judgment, when the number of particles does not exceed a predetermined quantity control limit value (the step S4, No), tendency analysis is continuously carried out with respect to the Eberhardt's index while continuing control using the regular quantity control chart (a step S5). As the tendency analysis, for example, it is possible to use a test which is provided as an anomaly judgment rule other than 3 sigma rules in JIS Z9021, e.g., a test on whether the Eberhardt's index I_{E} continuously shows an upward tendency, whether such a bias as that the Eberhardt's index I_{E} continuously takes a value larger or smaller than 4/π has occurred, or whether an increase and a decrease in the Eberhardt's index I_{E} are alternately repeated.

FIG. 2 shows an example of the Eberhardt's index control chart created in accordance with the procedure of the step S3 in FIG. 1.

In FIG. 2, reference sign EH1 denotes the Eberhardt's index IE; reference sign EH2, an upper control limit line UCL (Upper Control Limit) of the Eberhardt's index in a case of the Poisson distribution; reference sign EH3, a lower control limit line LCL (Lower Control Limit) of the Eberhardt's index in a case of the Poisson distribution; and reference sign EH4, an Eberhardt's index control reference value (=4/π).

In FIG. 2, a point indicated by reference sign EH5 is in the range considered to be random in the control chart, and a point indicated by reference sign EH6 has a high Eberhardt's index, and hence a cluster is considered to be present.

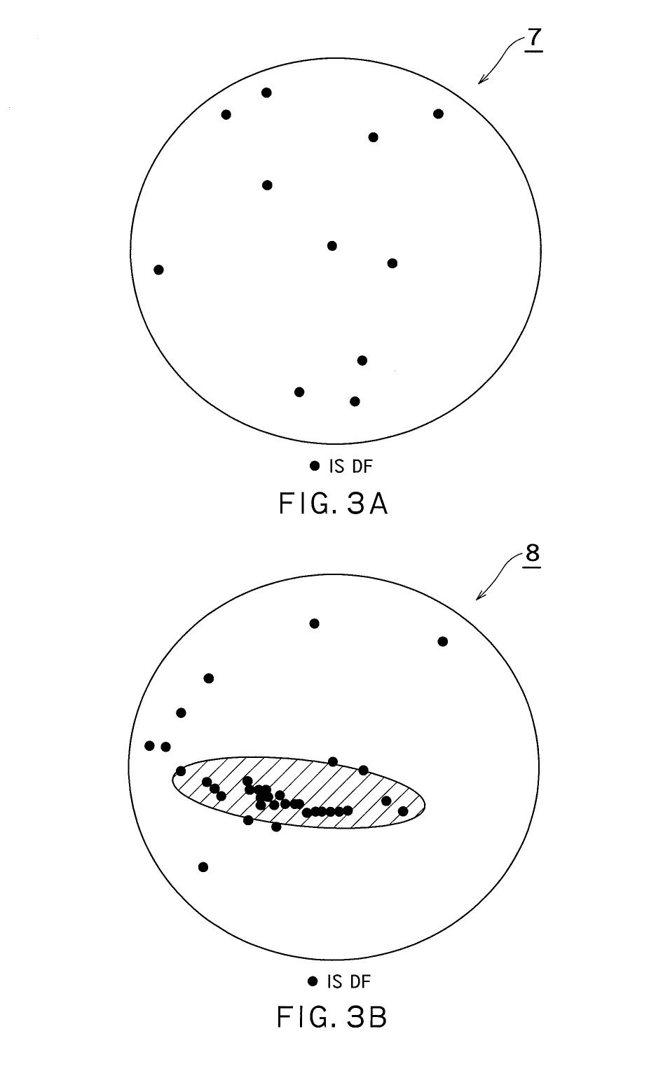

FIG. 3A and FIG. 3B show an example of a wafer map of defects corresponding to the Eberhardt's index control chart depicted in FIG. 2. Although a wafer map 7 shown in FIG. 3A looks like a random distribution in appearance, presence of a cluster can be recognized in a hatched portion in a wafer map 8 shown in FIG. 3B.

### (2) Embodiment 2

In this embodiment, in addition to the regular Eberhardt's index I_{E}, a one-dimensional Eberhardt's index is used to judge presence/absence of a change in state of a spatial point distribution. As the one-dimensional Eberhardt's index, there is used an Eberhardt's index calculated from a one-dimensional coordinate that is obtained by converting a coordinate of a defect or a particle generated on a wafer into a polar coordinate having the center of the wafer as an origin and performing projection onto a radius vector and an azimuthal component of the converted polar coordinate.

Giving a more specific description, ri representing a distance from the wafer center on the polar coordinate, and an azimuthal angle θi is used to represent a coordinate of each particle, and an index in the radial direction corresponds to the following expression:

I^{r}_{E}

This index is represented by the following expression (2):

$${I}_{E}^{r} = \frac{N {\sum }_{i = 1}^{N} {r}_{i}^{2}}{{( {\sum }_{i = 1}^{N} {r}_{i} )}^{2}} . \qquad ( 2 )$$

An index relative to the azimuthal angle corresponds to the following expression:

I^{θ}_{E}

This index is represented by the following expression (3):

$${I}_{E}^{θ} = \frac{N {\sum }_{i = 1}^{N} {θ}_{i}^{2}}{{( {\sum }_{i = 1}^{N} {θ}_{i} )}^{2}} . \qquad ( 3 )$$

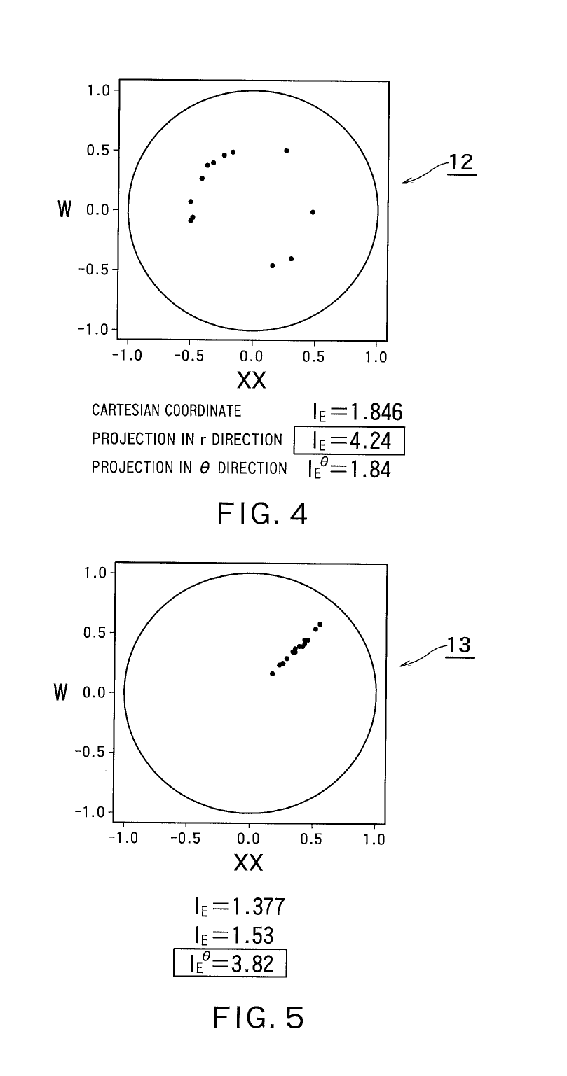

FIG. 4 shows an example of plotting the thus obtained particle distribution onto a wafer map.

Visually confirming the wafer map 12 in FIG. 4, although particles are concentrated on a position corresponding to r≈0.5, the number of these particles is small, these particles are sparse, and hence a value corresponding to a random distribution is presented in a case of a regular Eberhardt's index.

On the other hand, when the following value defined by the above Expression (2) is used, this value

I^{r}_{E}

is as very high as 4.24. In a one-dimensional spatial distribution, a distribution of a nearest neighbor distance in a case of a random distribution is an exponential distribution, an Eberhardt's index coincides with the Eberhardt's index control reference value 2 in the random distribution, aggregative arrangement is shown in a case of the Eberhardt's index higher than this value, and regular arrangement is shown in a case of the Eberhardt's index lower than this value. Therefore, in the case of the above example, it is suggested that the value

I^{r}_{E}

suggests such a distribution that particles concentrate on positions near specific r on the wafer map. As shown in FIG. 4, this point can be confirmed on the actual wafer map. In Embodiment 2, it can be understood from a sample distribution of the Eberhardt's index relative to the one-dimensional random point distribution, the upper control limit (a point of 95%) is 2.64 since the number of points is 12, this corresponds to, e.g., a second probability point in the example shown in FIG. 4, 4.24 is higher than this point, and hence a spatial distribution where points are aggregated at specific radial position is shown.

FIG. 5 shows another example of the wafer map obtained by the above Expressions (2) and (3). It can be understood from visual confirmation that particles are intensively distributed in a specific azimuth direction in the wafer map 13 of FIG. 5. However, in this case, since the number of the particles is not very large, the regular Eberhardt's index shows a value that can be classified into a random type like 1.377. In this case, the value

I^{θ}_{E}

shows a large value of 3.82. Therefore, a result that consistency with a wafer map aggregated in a given azimuth direction can be obtained. At this time, when the Eberhardt's index sample distribution relative to the random point distribution is used, since the number of points of the upper control limit (the points of 95%) is 14, and hence 2.63 is provided. When this value is compared with the above example, 3.82 in the above example is larger, and hence it can be understood that a spatial point distribution that is aggregated in a specific azimuth direction is provided. In the example shown in FIG. 5, 2.63 corresponds to, e.g., the second probability point.

According to the anomaly detection method of at least one of the above-described embodiments, since presence/absence of a change in state of the spatial point distribution relative to defects or particles can be judged on the statistical basis, troubles caused due to the manufacturing apparatus, a process, and a material can be accurately detected.

(B) Anomaly Detection Apparatus

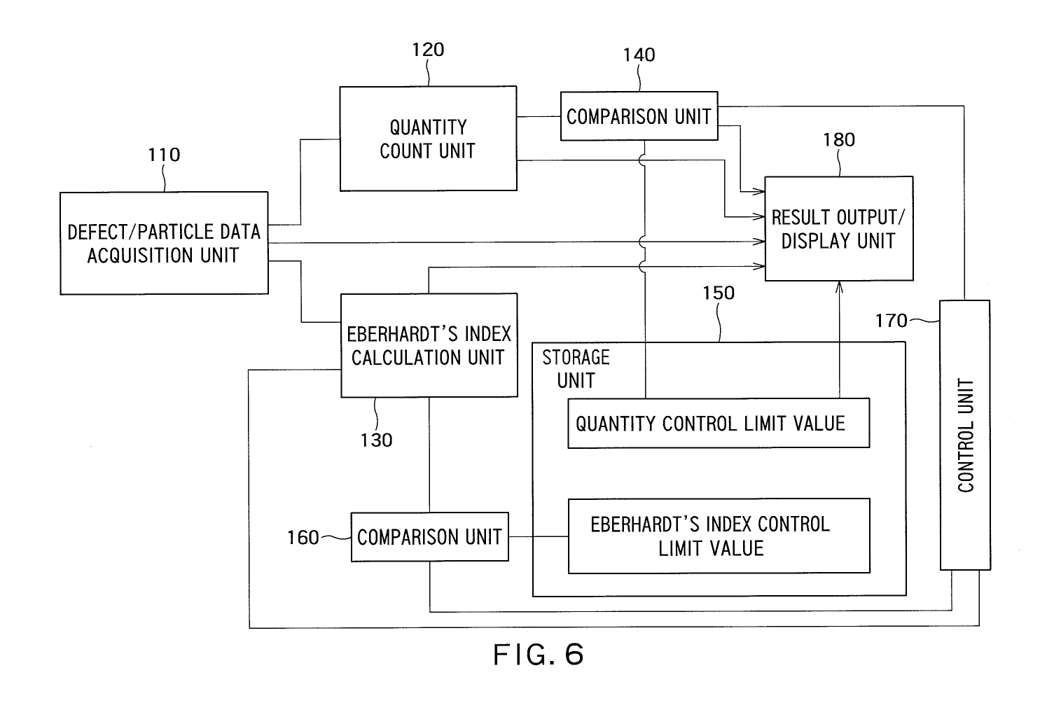

The anomaly detection apparatus according to the embodiment will now be described with reference to FIG. 6. The anomaly detection apparatus in FIG. 6 includes a defect/particle data acquisition unit 110, a quantity count unit 120, an Eberhardt's index calculation unit 130, comparison units 140 and 160, a storage unit 150, a control unit 170, and a result output display unit 180.

The defect/particle data acquisition unit 110 acquires data of an inspection result for a wafer that is being processed in a semiconductor manufacturing process which is a target of anomaly detection from a non-illustrated inspection apparatus, and supplies it to the quantity count unit 120, the Eberhardt's index calculation unit 130, and the result output display unit 180. The inspection result data includes a detected particle spatial coordinate.

The quantity count unit 120 receives the inspection result data from the defect/particle data acquisition unit 110, counts the number of particles detected by the non-illustrated examination apparatus, supplies a count result to the comparison unit 140, also supplies it to the result output display unit 180 so that data can be displayed through a liquid crystal display or the like.

The Eberhardt's index calculation unit 130 receives the inspection result data from the defect/particle data acquisition unit 110, calculates an Eberhardt's index I_{E} represented by Expression (1) from the particle spatial coordinate data detected by the non-illustrated examination apparatus, and supplies an obtained value to the control unit 170 and the comparison unit 160.

The storage unit 150 stores data of judgment threshold values, e.g., a predetermined quantity control limit value and an Eberhardt's index control limit value.

The comparison unit 140 compares the count result of the number of particles obtained by the quantity count unit 120 with the quantity control limit value stored in the storage unit 150, supplies a comparison result to the control unit 170, also supplies the same to the result output display unit 180 so that data can be displayed by a liquid crystal display or the like. In this embodiment, the comparison unit 140 corresponds to, e.g., a second comparison unit.

When it is found out, from the comparison result by the comparison unit, that the number of particles does not exceed the predetermined quantity control limit value, the control unit 170 performs the above-described tendency analysis with respect to the Eberhardt's index while maintaining the regular quantity control.

When it is found out, from the comparison result by the comparison unit, that the number of particles exceeds the predetermined quantity control limit value, the control unit 170 generates a command signal, supplies it to the comparison unit 160. The comparison unit 160 compares an Eberhardt's index calculated by the Eberhardt's index calculation unit 130 with an Eberhardt's index control reference value stored in the storage unit 150, and supplies a comparison result to the control unit 170. In this embodiment, the comparison unit 160 corresponds to, e.g., a first comparison unit.

It is found out from the comparison result that the Eberhardt's index is not significantly different from the Eberhardt's index control reference value, the control unit 170 continues control using a regular attribute control chart.

On the other hand, when it is revealed from the comparison result that the Eberhardt value is significantly larger than the Eberhardt's index control reference value, the control unit 170 determines that the spatial point distribution is aggregative, pays attention to presence of a cluster, and displays that characteristic of the spatial point distribution (Spatial Signature) in a wafer map should be examined in detail through the result output display unit 180.

Moreover, when it is revealed from the comparison result that the Eberhardt index is significantly lower than the Eberhardt's index control reference value, the control unit 170 determines that the spatial point distribution is regular, pays attention to presence of a common defect, and displays that the spatial point distribution of defects or particles on a wafer should be examined in detail through the result output display unit 180.

The anomaly detection apparatus shown in FIG. 6 can use not only the regular Eberhardt's index I_{E} but also a one-dimensional Eberhardt's index explained in Embodiment 2 of the anomaly detection method and judge presence/absence of a change in state of the spatial point distribution.

In this case, the defect/particle data acquisition unit 110 acquires data of the examination result relative to the wafer that is being processed, then converts a coordinate of each defect or particle into a polar coordinate having the center of the wafer as an origin, and acquires a one-dimensional coordinate based on projection onto a radius vector and an azimuthal component of the converted polar coordinate. The Eberhardt's index calculation unit 130 calculates a one-dimensional Eberhardt's index from the one-dimensional coordinate supplied from the defect/particle data acquisition unit 110. The storage unit 150 stores not only 4/π as the Eberhardt's index control reference value but also a numeral value “2”, and the comparison unit 160 compares the one-dimensional Eberhardt's index supplied from the Eberhardt's index calculation unit 130 with the Eberhardt's index control reference value 2 and supplies a comparison result to the control unit 170.

According to the anomaly detection apparatus of at least one of the foregoing embodiments, since presence/absence of a change in state of the spatial point distribution relative to defects or particles can be judged on the statistical basis, troubles caused due to the manufacturing apparatus, a process, and a material can be accurately detected.

(C) Program

A series of procedures of anomaly detection according to each of the foregoing embodiments may be incorporated into a program, and it may be read and executed by a computer. As a result, each series of procedures in the anomaly detection can be realized by using a general-purpose computer without being restricted to, e.g., the anomaly detection apparatus shown in FIG. 6. Furthermore, each series of procedures in the anomaly detection may be stored in a recording medium such as a flexible disk or a CD-ROM as a program to be executed by a computer, and it may be read and executed by the computer. The recording medium may be a fixed type recording medium such as a hard disk device or a memory without being restricted to a portable type such as a magnetic disk or an optical disk. Moreover, the program in which each series of procedures in the anomaly detection may be distributed through a communication circuit (including wireless communication), e.g., the Internet. Additionally, the program in which each series of procedures in the anomaly detection may be distributed through a wired circuit or a wireless circuit in an encrypted, modulated, or compressed state, and it may be distributed while being stored in the recording medium.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions.

For example, in the anomaly detection method according to Embodiment 1, the quantity control and the control using an Eberhardt's index are combined to each other, but they may be independently carried out. Further, as a subsequent flow in a case where the Eberhardt's index is significantly larger or smaller than 4/π, various methods can be used without being restricted to the procedure shown in FIG. 1. For example, it is possible to adopt a method of, e.g., providing a further control limit to a value of I_{E}, conducting maintenance of a specific process device may be performed when the value greatly deviates, or scraping a wafer.

Additionally, according to the anomaly detection method of Embodiment 2, the description has been given as to the method of judging presence/absence of a change in state of the spatial point distribution with use of not only the regular Eberhardt's index I_{E} but also the one-dimensional Eberhardt's index. However, the present invention is not restricted to these methods, and presence/absence of a change in state of a spatial point distribution may be judged by using the one-dimensional Eberhardt's index alone. As a result, a biased conformation of defects or particles can be judged. In this case, a value 2.64 or 2.63 corresponds to, e.g., the first probability point.

Further, in the foregoing embodiment, although the defect distribution relative to the spatial coordinate has been described, the present invention is not restricted thereto. For example, a time at which a specific defect is produced, or an ID and a chamber number of a process apparatus that produces a specific defect may be used for the coordinate. In this case, as to a defect that is produced at specific time intervals, when the one-dimensional Eberhardt's index is significantly larger than 2, defect generation events occur at equal intervals, and this situation can be considered as a random event in terms of time if the Eberhardt's index is close to 2. Moreover, the time, the process apparatus ID, the chamber number and others can be combined with the spatial coordinate.

The accompanying claims and their equivalents are intended to cover such forms or modifications as would fall within the scope and spirit of the inventions.

1. An anomaly detection method comprising:
acquiring coordinate data of defects or particles generated on a wafer during a semiconductor manufacturing process;
calculating an Eberhardt's index from the acquired data;
calculating a first probability point based on a sample distribution of the Eberhardt's index; and
comparing the calculated Eberhardt's index with the first probability point, and judging presence/absence in state of a spatial point distribution relative to the defects or the particles.

2. The method of claim 1,
wherein a sample distribution of the Eberhardt's index is a sample distribution relative to a spatial point distribution according to a binomial distribution or a Poisson distribution.

3. The method of claim 1,
wherein comparing the calculated Eberhardt's index with the first probability point comprises
comparing the calculated Eberhardt's index with a first Eberhardt's index control reference value.

4. The method of claim 3,
wherein, when the calculated Eberhardt's index substantially coincides with the first Eberhardt's index control reference value, the spatial distribution is determined as a random spatial distribution.

5. The method of claim 3,
wherein, when the calculated Eberhardt's index is significantly larger than the first Eberhardt's index control reference value, the spatial distribution is determined to be aggregative.

6. The method of claim 5, further comprising paying attention to presence of a cluster and examining characteristics of a spatial point distribution (Spatial Signature) of a wafer map.

7. The method of claim 3,
wherein, when the calculated Eberhardt's index is significantly smaller than the first Eberhardt's index control reference value, the spatial distribution is determined to be regular.

8. The method of claim 7, further comprising examining presence/absence of a common defect.

9. The method of claim 1,
wherein the acquired coordinate data is converted into a polar coordinate having the center of the wafer as an origin and acquired, and
the Eberhardt's index is an Eberhardt's index relative to a one-dimensional coordinate calculated based on projection of the polar coordinate onto a radius vector and an azimuthal component.

10. The method of claim 2, further comprising:
converting the acquired coordinate of the defect or the particle into a polar coordinate having the center of the wafer as an origin;
calculating a one-dimensional coordinate based on projection of the polar coordinate onto a radius vector and an azimuthal component;
calculating an Eberhardt's index relative to the one-dimensional coordinate; and
comparing an Eberhardt's index relative to the calculated primary coordinate with a second probability point calculated from an index distribution.

11. The method of claim 10,
wherein comparing the Eberhardt's index relative to the calculated one-dimensional coordinate with the second probability point comprises comparing the Eberhardt's index relative to the calculated one-dimensional coordinate with a second Eberhardt's index control reference value.

12. The method of claim 11,
wherein, when the calculated Eberhardt's index substantially coincides with the second Eberhardt's index control reference value, the spatial distribution is determined as a random spatial distribution.

13. The method of claim 11,
wherein, when the calculated Eberhardt's index is significantly larger than the second Eberhardt's index control reference value, the spatial distribution is determined to be aggregative.

14. The method of claim 11,
wherein, when the calculated Eberhardt's index is significantly smaller than the second Eberhardt's index control reference value, the spatial distribution is determined to be regular.

15. The method of claim 1, further comprising:
counting the number of the defects or the particles; and
comparing a result of counting with a predetermined quantity control limit value,
wherein the calculated Eberhardt's index is compared with the first probability point when the result of counting exceeds the quantity control limit value, and
the Eberhardt's index is subjected to tendency analysis when the result of counting exceeds the quantity control limit value.

16. A non-transitory computer-readable recording medium containing a program which causes a computer to execute an anomaly detection, the anomaly detection comprising:
acquiring coordinate data of defects or particles generated on a wafer during a semiconductor manufacturing process;
calculating an Eberhardt's index from the acquired data;
calculating a first probability point based on a sample distribution of the Eberhardt's index; and
comparing the calculated Eberhardt's index with the first probability point, and judging presence/absence in state of a spatial point distribution relative to the defects or the particles.

17. The medium of claim 16,
wherein a sample distribution of the Eberhardt's index is a sample distribution relative to a spatial point distribution according to a binomial distribution or a Poisson distribution.

18. The medium of claim 16,
wherein the acquired coordinate data is converted into a polar coordinate having the center of the wafer as an origin and acquired, and
the Eberhardt's index is an Eberhardt's index relative to a one-dimensional coordinate calculated based on projection of the polar coordinate onto a radius vector and an azimuthal component.

19. An anomaly detection apparatus comprising:
an arithmetic unit configured to calculate an Eberhardt's index from coordinate data of a defect or a particle generated on a wafer in manufacturing a semiconductor;
a storage unit configured to store a probability point based on a sample distribution of a previously calculated or determined Eberhardt's index; and
a first comparison unit configured to compare the calculated Eberhardt's index with the probability point.

20. The apparatus of claim 19,
wherein the storage unit further stores a quantity control limit value of the defects or the particles, and
the apparatus further comprises:
a counting unit configured to count the number of the defects or the particles; and
a second comparison unit configured to compare the counted number with the quantity control limit value.
